(19) United States
(12) Patent Application Publication
(10) Pub. No.: US 2008/0044666 A1
(43) Pub. Date: Feb. 21, 2008

(54) Amine-neutralized ethylene acid copolymers, shaped articles and laminates produced therefrom

(76) Inventors: Jerrel C. Anderson, Vienna, WV (US); Richard A. Hayes, Beaumont, TX (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/506,101

(22) Filed: Aug. 17, 2006

(51) Int. Cl. B32B 15/08; B32B 27/30; B32B 17/10; C08L 77/00

(52) U.S. Cl. 428/441; 428/522; 428/461; 525/178

(57) ABSTRACT

The present invention provides a resin composition comprising an amine-neutralized ethylene acid copolymer. These resin compositions copolymers may be characterized by enhanced adhesiveness and reduced crystallinity. Also provided are shaped articles, multilayer films or sheets, and laminate articles comprising the resin composition.

### FIELD OF THE INVENTION

The present invention relates to resin compositions suitable for use as an intermediate layer in laminate articles.

### BACKGROUND OF THE INVENTION

Several patents and publications are cited in this description in order to more fully describe the state of the art to which this invention pertains. The entire disclosure of each of these patents and publications is incorporated by reference herein.

Glass laminated products have contributed to society for almost a century. Beyond the well known, every day automotive safety glass used in windshields, laminated glass is used in all forms of the transportation industry. It is utilized as windows for trains, airplanes, ships, and nearly every other mode of transportation. Safety glass is characterized by high impact and penetration resistance and does not scatter glass shards and debris when shattered.

Safety glass typically consists of a sandwich of two glass sheets or panels bonded together with an interlayer of a polymeric film or sheet, which is placed between the two glass sheets. One or both of the glass sheets may be replaced with optically clear rigid polymeric sheets, such as sheets of polycarbonate materials. Safety glass has further evolved to include multiple layers of glass and polymeric sheets bonded together with interlayers of polymeric films or sheets.

The interlayer is typically made with a relatively thick polymer film or sheet, which exhibits toughness and bondability to provide adhesion to the glass in the event of a crack or crash. Over the years, a wide variety of polymeric interlayers have been developed to produce laminated products. In general, these polymeric interlayers must possess a combination of characteristics including very high optical clarity (low haze), high impact resistance, high penetration resistance, excellent ultraviolet (UV) light resistance, long term thermal stability, excellent adhesion to glass and other rigid polymeric sheets, low UV light transmittance, low moisture absorption, high moisture resistance, and excellent long term weatherability, among other requirements.

A more recent trend has been the use of glass laminated products in the construction business for homes and office structures. The use of architectural glass has expanded rapidly over the years as designers have incorporated more glass surfaces into buildings.

In addition, glass laminated products have now reached the strength requirements for being incorporated as structural elements within buildings. Examples of weight-bearing safety glass structures that are now practical design choices include staircases and balustrades.

Copolyethylene ionomeric interlayers have been developed over the past half-century to meet these ever more demanding societal needs. Some examples of these developments are described in the following patents.

Rees, in U.S. Pat. No. 3,344,014, describes laminate interlayers derived from an ethylene copolymer ionomer neutralized with a diamine.

Clock, et al., in U.S. Pat. No. 3,762,988, describe a laminate interlayer which may include a core layer derived from neutralized poly(ethylene-co-methacrylic acid).

Bolton, et al., in U.S. Pat. Nos. 4,799,346 and 5,002,820, describe laminated glass which includes an amine crosslinked partially neutralized ethylene-carboxylic acid ionomer resin interlayer.

Naoumenko, et al., in U.S. Pat. Nos. 5,895,721 and 6,238,801, describe a glazing which includes a transparent layer of an ionomer resin with improved adhesion through the use of metal chelates.

Bravet, et al., in U.S. Pat. No. 6,265,054, describe certain glass laminate interlayers derived from ethylene-methacrylic acid copolymers which have been neutralized with polyamines.

While laminated glass products which incorporate copolyethylene ionomeric interlayers have met many of the demands placed on them by society, ever increasing demands require yet further developments. For example, the above mentioned U.S. Pat. Nos. 5,895,721 and 6,238,801 have described the need of additional adhesives and primers in glass laminates that incorporate copolyethylene ionomeric interlayers.

The films or sheets derived from the amine-neutralized copolyethylene ionomeric compositions of the present invention demonstrate excellent adhesion to glass and other laminating layers. In addition, the films or sheets derived from the amine-neutralized copolyethylene ionomeric compositions of the present invention have reduced levels of crystallinity, and which in turn provides enhanced clarity.

### SUMMARY OF THE INVENTION

In one aspect, the present invention provides a resin composition comprising or consisting essentially of an ethylene acid copolymer. The ethylene acid copolymer comprises or consists essentially of polymerized residues of ethylene and from about 21 to about 30 wt % of polymerized residues of α,β-unsaturated carboxylic acids having from 3 to 8 carbons. The ethylene acid copolymer is neutralized with amines at a level of about 1 to 100 mol %, based on the total content of acid residues in the copolymer. In one specific embodiment, the ethylene acid copolymers of the present invention have a melt index (MI) of about 60 g/10 min or less prior to neutralization. In another specific embodiment, the ethylene acid copolymers of the present invention further comprises a finite amount up to about 50 wt % of at least one other unsaturated comonomer selected from the group consisting of acid derivatives having from 2 to 10 carbons. In a further specific embodiment, the resin composition of the present invention further comprises at least one additive selected from the group consisting of thermal stabilizers, secondary thermal stabilizers, UV absorbers, UV stabilizers, hindered amine light stabilizers (HALS), plasticizers, processing aides, flow enhancing additives, lubricants, pigments, dyes, colorants, flame retardants, impact modifiers, nucleating agents, and anti-blocking agents.

In another aspect, the present invention is a shaped article comprising the resin composition of the present invention.

In yet another aspect, the present invention is a multilayer film or sheet comprising at least one polymeric layer comprising the resin composition of the present invention.

In yet another aspect, the present invention is a laminate article comprising at least one polymeric interlayer comprising the resin composition of the present invention.

### DETAILED DESCRIPTION OF THE INVENTION

### DEFINITIONS

The following definitions apply to the terms as used throughout this specification, unless otherwise limited in specific instances.

The term “(meth)acrylic”, as used herein, alone or in combined form, such as “(meth)acrylate”, refers to acrylic and/or methacrylic, for example, acrylic acid and/or methacrylic acid, or alkyl acrylate and/or alkyl methacrylate.

The terms “finite amount” and “finite value”, as used herein, are interchangeable and refer to an amount that is greater than zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, when used alone herein, is inclusive; more specifically, the phrase “A or B” means “A, B, or both A and B”. Exclusive “or” is designated herein by terms such as “either A or B” and “one of A or B”, for example.

All percentages, parts, ratios, and the like set forth herein are by weight, unless otherwise limited in specific instances.

In the present application, the term “sheet” is used in its broad sense to denote both sheets and films, and the term “film” is used in its broad sense to denote both sheets and films.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

### Amine-Neutralized Ethylene Acid Copolymers

In one aspect, the present invention provides a resin composition of certain amine-neutralized ethylene acid copolymers. The amine-neutralized ethylene acid copolymers of the present invention comprise or consist essentially of copolymerized residues of ethylene and of one or more α,β-ethylenically unsaturated carboxylic acids. Suitable ethylene acid copolymers comprise about 21 to about 30 wt %, and preferably about 21 to about 25 wt %, of residues of α,β-ethylenically unsaturated carboxylic acids based on the total weight of the polymer. More preferably, the amine-neutralized ethylene acid copolymers comprise from about 21 to about 23 wt % of residues of α,β-ethylenically unsaturated carboxylic acids.

Suitable α,β-ethylenically unsaturated carboxylic acids include, but are not limited to, acrylic acids, methacrylic acids, itaconic acids, maleic acids, maleic anhydrides, fumaric acids, monomethyl maleic acids, and mixtures thereof. Preferably, the α,β-ethylenically unsaturated carboxylic acids are selected from the group consisting of acrylic acids, methacrylic acids, and mixtures thereof. It should be understood for the purposes of the present application that control of the final acid level in a copolymer of the present invention is not exact, and therefore the range of acid in a final product may vary within about ±1 wt % of the disclosed ranges without departing from the intended scope of the present invention.

The amine-neutralized ethylene acid copolymers may optionally contain other unsaturated comonomers derived from unsaturated acids having from two (2) to ten (10) carbons, preferably unsaturated acids having from three (3) to eight (8) carbons. Suitable acid derivatives include acid anhydrides, amides, and esters. Esters are preferred. Specific examples of preferred esters of unsaturated carboxylic acids include, but are not limited to, methyl acrylates, methyl methacrylates, ethyl acrylates, ethyl methacrylates, propyl acrylates, propyl methacrylates, isopropyl acrylates, isopropyl methacrylates, butyl acrylates, butyl methacrylates, isobutyl acrylates, isobutyl methacrylate, tert-butyl acrylates, tert-butyl methacrylates, octyl acrylates, octyl methacrylates, undecyl acrylates, undecyl methacrylates, octadecyl acrylates, octadecyl methacrylates, dodecyl acrylates, dodecyl methacrylates, 2-ethylhexyl acrylates, 2-ethylhexyl methacrylates, isobornyl acrylates, isobornyl methacrylates, lauryl acrylates, lauryl methacrylates, 2-hydroxyethyl acrylates, 2-hydroxyethyl methacrylates, glycidyl acrylates, glycidyl methacrylates, poly(ethylene glycol)acrylates, poly(ethylene glycol)methacrylates, poly(ethylene glycol)methyl ether acrylates, poly(ethylene glycol)methyl ether methacrylates, poly(ethylene glycol)behenyl ether acrylates, poly(ethylene glycol)behenyl ether methacrylates, poly(ethylene glycol) 4-nonylphenyl ether acrylates, poly(ethylene glycol) 4-nonylphenyl ether methacrylates, poly(ethylene glycol)phenyl ether acrylates, poly(ethylene glycol)phenyl ether methacrylates, dimethyl maleates, diethyl maleates, dibutyl maleates, dimethyl fumarates, diethyl fumarates, dibutyl fumarates, dimenthyl fumarates, vinyl acetates, vinyl propionates, and the like and mixtures thereof. Preferably, the other unsaturated comonomers are selected from the group consisting of methyl acrylates, methyl methacrylates, butyl acrylates, butyl methacrylates, glycidyl methacrylates, vinyl acetates, and mixtures thereof.

Preferably, the amine-neutralized ethylene acid copolymers of the present invention incorporate a finite amount up to about 50 wt % of the other unsaturated comonomer, based on the total weight of the neutralized copolymer. More preferably, the amine-neutralized ethylene acid copolymers of the present invention incorporate a finite amount up to about 25 wt % of the other unsaturated comonomer.

The amine-neutralized ethylene acid copolymers of the present invention may be polymerized as described, for example, in U.S. Pat. Nos. 3,404,134; 5,028,674; 6,500,888; and 6,518,365.

The ethylene acid copolymers are neutralized with one or more amines to a level of from about 1 to about 100 mol %, based on the copolymer's total carboxylic acid content. The amines may be aliphatic or cycloaliphatic. They may be diamines, triamines, or polyamines. They may incorporate primary amine functions, secondary amine functions, or mixtures thereof. Preferably, the amine component incorporates primary amine functions. Without wishing to be held to any theory, it is believed that primary amines provide the strongest interaction, based on stereochemical considerations. Preferably, the amine component incorporates from 2 to 100 carbon atoms. More preferably, the amine component incorporates from 2 to 50 carbon atoms. Specific examples of preferable amines include, but are not limited to, ethylene diamine, 1,3-diaminopropane, 1,2-diaminopropane, 1,4-diaminobutane, 1,2-diamino-2-methylpropane, 1,3-diaminopentane, 1,5-diaminopentane, 2,2-dimethyl, 1,3-propanediamine, 1,6-hexanediamine, 2-methyl-1,5-pentanediamine, 1,7-diaminoheptane, 1,8-diaminooctane, 1,9-diaminononane, 1,10-diaminodecane, 1,12-diaminododecane, bis(4-aminocyclohexyl)methane, diethylenetriamine, beta, beta′-diaminodiethyl ether, beta, beta′-diaminodiethyl thioether, 4,9-dioxa-1,12-dodecanediamine, 4,7,10-trioxa-1,13-tridecanediamine, N-(2-aminoethyl)-1,3-propanediamine, 3,3′diamino-N-methyidipropylamine, 3,3′iminobispropylamine, spermidine, bis(hexamethylene)triamine, triethylenetetramine, N,N′-bis(3-aminopropyl)ethylenediamine, N,N′-bis(2-aminoethyl)-1,3-propanediamine, N,N′-bis(3-aminopropyl)-1,3-propanediamine, spermine, tris(2-aminoethyl)amine, tetraethylenepentamine, pentaethylenehexamine, phenylene diethyl amine, 1,3-diaminomethylxylene, 4,4′methylenebis(2-methylcyclohexylamine), 1,2-diaminocyclohexane, 1,3-diaminocyclohexane. 1,4-diaminocyclohexane, bis(1,3-aminomethyl)cyclohexane, isophorone diamine, 1,8-diamino-p-menthane, piperazine, 4,4′trimethylenedipiperidine, and the like and mixtures thereof. The degree of neutralization may be calculated from the amount of amine added to a copolymer of known acid content, or it may be directly measured through established analytical methods, as described, for example, in U.S. Pat. No. 3,328,367. More specifically, the degree of neutralization may be calculated based on the changes in the infrared absorption spectrum of the copolymer, as described in U.S. Pat. No. 3,471,460.

Preferably, the amine-neutralized ethylene acid copolymers are neutralized from about 10 to about 90 mol % with amines based on the total number of equivalents of copolymerized carboxylic acid residues in the ethylene acid copolymer. More preferably, the amine-neutralized ethylene acid copolymers are neutralized from about 20 to 80 mol % with amines.

The amine-neutralized ethylene acid copolymers may optionally be further neutralized with metallic ions. The metallic ions may be monovalent, divalent, trivalent, multivalent, and mixtures thereof. Preferable monovalent metallic ions may be selected from the group consisting of sodium, potassium, lithium, silver, mercury, copper, and the like and mixtures thereof. Preferable divalent metallic ions may be selected from the group consisting of beryllium, magnesium, calcium, strontium, barium, copper, cadmium, mercury, tin, lead, iron, cobalt, nickel, zinc, and the like and mixtures thereof. Preferable trivalent metallic ions may be selected from the group consisting of aluminum, scandium, iron, yttrium, and the like and mixtures thereof. Preferable multivalent metallic ions may be selected from the group consisting of titanium, zirconium, hafnium, vanadium, tantalum, tungsten, chromium, cerium, iron, and the like and mixtures therefrom. Preferably, when the metallic ion is multivalent, complexing agents, such as stearate, oleate, salicylate, and phenolate radicals are included, as described in U.S. Pat. No. 3,404,134. More preferably, the metallic ion may be selected from the group consisting of sodium, lithium, magnesium, zinc, aluminum, and mixtures thereof. Still more preferably, the metallic ion may be selected from the group consisting of sodium, zinc, and mixtures thereof. The sodium is particularly preferred in applications requiring high optical clarity. The zinc metallic ion is particularly preferred in applications requiring high moisture resistance.

The amine-neutralized ethylene acid copolymers may be neutralized in a finite amount up to about 99 mol % with metallic ions, based on the total number of equivalents of copolymerized carboxylic acid residues in the ethylene acid copolymer, when metallic ions are used. Preferably, the amine-neutralized ethylene acid copolymers are neutralized in a finite amount up to about 90 mol %, and more preferably up to 80 mol % with metallic ions.

The amine-neutralized ethylene acid copolymers of the present invention may be neutralized as disclosed, for example, in U.S. Pat. No. 3,404,134. If complete or essentially complete neutralization is desired, it may be necessary to combine the acid copolymer with a stoichiometric excess, preferably a small stoichiometric excess, of the amine or metallic ion.

The ethylene acid copolymers preferably have a MI of less than 60 grams/10 min prior to neutralization as determined by ASTM D1238 at 190° C. and under a weight of 2.16 kg, and preferably less than 55 grams/10 min. More preferably the MI is less than 50 grams/10 min. Even more preferably the MI is less than 35 grams/10 min. After neutralization, the MI may be less than 2.5 grams/10 min, and possibly less than 1.5 g/10 min.

The resin compositions of the present invention may be used with one or more additives that will be known to those of skill in the art. Such additives may include thermal stabilizers, for example, phenolic antioxidants; secondary thermal stabilizers, for example, thioethers and phosphites; UV absorbers, for example benzophenone- and benzotriazole-derivatives; UV stabilizers, for example, hindered amine light stabilizers (HALS), and the like. The additives may further include plasticizers, processing aides, flow enhancing additives, lubricants, pigments, dyes, colorants, flame retardants, impact modifiers, nucleating agents to increase crystallinity, antiblocking agents such as silica, and the like. For example, a colorant may be added to color the laminate comprising the resin composition or to control the incoming solar light. Typical colorants may also include a bluing agent to reduce yellowing.

Specific examples of plasticizers, which may be added to improve processing, final mechanical properties, or to reduce rattle or rustle of the films and sheets of the present invention, include, but are not limited to, stearic acid, oleic acid, soybean oil, epoxidized soybean oil, corn oil, caster oil, linseed oil, epoxidized linseed oil, mineral oil, alkyl phosphate esters, and other compatible low molecular weight polymers and the like and mixtures thereof.

If higher levels of adhesion are desired, silane coupling agents may be incorporated into the resin composition of the present invention. Specific examples of useful silane coupling agents include, but are not limited to, gamma-chloropropylmethoxysilane, vinyltrichlorosilane, vinyltriethoxysilane, vinyltris(beta-methoxyethoxy)silane, gamma-methacryloxypropyltrimethoxysilane, beta-(3,4-epoxycyclohexyl)ethyltrimethoxysilane, gammaglycidoxy propyltrimethoxysilane, vinyl-triacetoxysilane, gamma-mercaptopropyl trimethoxysilane, gamma-aminopropyltriethoxysilane, N-beta-(aminoethyl)-gamma-aminopropyl-trimethoxysilane, and the like and combinations thereof. Typically, the silane coupling agents are added at a level of about 0.01 to about 5 wt % based on the total weight of the resin composition.

Suitable levels of these additives and methods of incorporating the additives into polymer compositions will be available to those of skill in the art. See, for example, “Modern Plastics Encyclopedia”, McGraw-Hill, New York, N.Y. 1995.

Any suitable process known or yet to be known within the art may be used to neutralize the ethylene acid copolymers disclosed herein. For example, the ethylene acid copolymer may be dissolved in a suitable solvent and then mixed with the amine or a solution of the amine, as disclosed within U.S. Pat. No. 3,471,460. Alternatively, the neutralization of the ethylene acid copolymer may take place in slurry. The ethylene acid copolymer particles are mixed with the amine or a solution of the amine. Typically two to four equivalents of the amine component, based on the desired neutralization level, would be added within a slurry process. Stated alternatively, the amine should be added in an amount that is two to four times in excess of the amount that is theoretically required to attain the desired neutralization level. For example, if a neutralization level of 20 mol % is desired, then 0.4 to 0.8 equivalents of amine should be added to the slurry. The slurry should be maintained within a temperature range of about room temperature to about 100° C., preferably about 50° C. to about 100° C. The solvent used in the solution of the amine may be any solvent for the amine component such as, for example, water, lower aliphatic alcohols, such as methanol, ethanol, propanol, and the like, and mixtures thereof. Such slurry processes are disclosed in U.S. Pat. No. 3,404,134.

Preferably, the neutralization process involves intensive mixing of the molten ethylene acid copolymer with the amine component, the optional metal ion component and other optional components. The intensive mixing may be provided through static mixers, rubber mills, Brabender mixers, single screw extruders, twin screw extruders, and the like. The ethylene acid copolymer may be dried prior to any mixing step. The ethylene acid copolymer may then be mixed with the amine component, the optional metal ion component, and the other optional components as a dry blend, typically referred to as a “pellet blend”. Alternatively, the ethylene acid copolymer and the amine component may be coded through two different feeders. In an extrusion process, the ethylene acid copolymer and the amine component would typically be fed into the back, feed section of the extruder. However, this should not be considered limiting. The ethylene acid copolymer and the amine component may be advantageously fed into two different locations of the extruder. For example, the ethylene acid copolymer may be added in the back, feed section of the extruder while the amine component is fed in the front of the extruder near the die plate. The extruder temperature profile is set up to allow the ethylene acid copolymer and the amine component to melt under the processing conditions. The screw design will also provide stress and, in turn, heat, to the resin as it mixes the molten ethylene acid copolymer with the amine component.

Generally, the ethylene acid copolymer melt processing temperature will be within the range of about 50° C. to about 300° C. Preferably, the ethylene acid copolymer melt processing temperature will be within the range of about 100° C. to about 300° C. More preferably, the ethylene acid copolymer melt processing temperature will be within the range of about 130° C. and about 200° C.

Preferably, the amine component is dissolved within a solvent, such as water. The aqueous solution of the amine component may then be pumped into an intensive mixing zone and compounded with the molten ethylene acid copolymer. For example, the ethylene acid copolymer may be fed into the feeder section of an extruder, melted, and the aqueous amine solution may be pumped into the first sections of the extruder to be combined with the mixed, molten ethylene acid copolymer. The water byproduct and solvent may then be removed through vacuum ports connected into the back sections of the extruder. The metal ion component, if included within the composition, may also be dissolved in a suitable solvent, such as water, and added to the reaction mixture together with the amine component, if desired.

### Shaped Articles

In another aspect, the present invention provides shaped articles formed from the resin composition of the invention. The shaped articles may take the form of films, sheets, filaments, molded products, thermoformed products, and the like.

Preferably, the shaped article is a film or sheet comprising the resin composition of the invention and an effective amount of UV light absorbers, and optionally an effective amount of thermal stabilizers.

Typically, the polymeric sheets of the present invention have a thickness of about 10 mils (0.25 mm) or greater; more preferably about 15 mils (0.38 mm) or greater; still more preferably about 30 mils (0.75 mm) or greater; and still more preferably about 50 mils (1.25 mm) or greater. Enhanced penetration strength is necessary within the present invention to satisfy many of the current mandated requirements for hurricane and threat resistance. Thus, many enduses in the current environment may require the amine-neutralized ethylene acid copolymer interlayer to be even thicker. Interlayers thicker than60 mils (1.50 mm), 90 mils (2.25 mm), and even thicker than 120 mils (3.00 mm), are becoming common within the marketplace.

For purposes of this invention, a film may be less than or equal to about 10 mils (0.25 mm) thick, preferably between about 1 mil (0.025 mm) and about 6 mils (0.15 mm). However, thicker films can be formed up to a thickness of about 20 mils (0.50 mm).

The films and sheets of the present invention may be produced by any suitable process known or yet to be known within the art. For example, the films and sheets of the present invention may be formed through dipcoating, solution casting, compression molding, injection molding, melts extrusions, melt blowing, or any other procedures that are known to those of skill in the art.

The films and sheets of the present invention are preferably formed by extrusion, which is a particularly preferred process for formation of “endless” products. In extrusion, the polymeric material, whether provided as a molten polymer or as plastic pellets or granules, is fluidized and homogenized. Preferably, the melt processing temperature of the amine-neutralized ethylene acid copolymer compositions of the present invention is from about 50° C. to about 300° C. More preferably, the melt processing temperature of the amine-neutralized ethylene acid copolymer compositions of the present invention is from about 100° C. to about 250° C. Most preferably, the melt processing temperature of the resin compositions of the present invention is from about 130° C. to about 200° C. The resin compositions of the present invention have excellent thermal stability, which allows for processing at temperatures that are high enough to reduce the effective melt viscosity.

Both newly polymerized resin compositions and recycled resin compositions may be used to produce the shaped articles of the present invention.

The UV light absorber or other additive(s), as described above, may be added to the molten mixture, if desired. This mixture is then forced through a suitably shaped die to produce the desired cross-sectional film or sheet shape. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders may be used. Different kinds of dies are used to produce different products, such as blown film (formed by a blow head for blown extrusions), sheets and strips (slot dies) and hollow and solid sections (circular dies). In this manner, films and sheets of different widths and thickness may be produced. After extrusion, the polymeric film or sheet is taken up on rollers, cooled and taken off by means of suitable devices that are designed to prevent any subsequent deformation of the film.

Using extruders known in the art, film and sheets can be produced by extruding a thin layer of polymer over chilled rolls and then further drawing the film or sheet down to size by tension rolls. In the extrusion casting process, the polymer melt is conveyed from the extruder through a slot die (T-shaped or “coat hanger” die). The die may be as wide as 10 feet and typically has thick wall sections on the final lands to minimize deflection of the lips from internal pressure. Die openings may be within a wide range, but 0.015 to 0.030 inch is typical. The nascent cast film or sheet may be drawn down, and thinned significantly, depending on the speed of the rolls taking up the film or sheet. The film or sheet is then solidified by cooling below the crystalline melting point or glass transition temperature. This may be accomplished by passing the film or sheet through a water bath or over two or more chrome-plated chill rolls which have been cored for water cooling. The cast film or sheet is then conveyed though nip rolls, a slitter to trim the edges, and then wound up. In casting processes, conditions may be tailored to allow a relatively high degree of orientation in the machine direction, especially at high drawing ratios and high wind up speeds, and a much lower level of orientation in the transverse direction. Alternatively, the conditions may be tailored to minimize the level of orientation, thus providing films or sheets with essentially equivalent physical properties in both the machine direction and the transverse direction.

Blown film, which is generally stronger, tougher, and made more rapidly than cast film, is made by extruding a tube. In producing blown film, the melt flow of molten polymer is typically turned upward from the extruder and fed through an annular die. In so doing, the melt flows around a mandrel and emerges through the ring-shaped opening in the form of a tube. As this tube leaves the die, internal pressure is introduced through the die mandrel with air, which expands the tube from about 1.5 to about 2.5 times the die diameter and simultaneously draws the film, causing a reduction in thickness. The air contained in the bubble cannot escape because it is sealed by the die on one end and by nip (or pinch) rolls on the other. Desirably, an even air pressure is maintained to ensure uniform thickness of the film bubble. The tubular film may be cooled internally and/or externally by directing air onto the film. Faster quenching in the blown film method may be accomplished by passing the expanded film about a cooled mandrel which is situated within the bubble. For example, one such method using a cooled mandrel is described by Bunga, et. al., in Canadian Pat. No. 893,216. If the polymer which is being used to prepare blown film is semicrystalline, the bubble may become cloudy as it cools below the softening point of the polymer.

For manufacturing large quantities of film or sheet, a sheeting calender may be employed. The film or sheet is fed into the gap of the calender, a machine comprising a number of heatable parallel cylindrical rollers which rotate in opposite directions and spread out the polymer and stretch it to the required thickness. The last roller smooths the film or sheet thus produced. If the film or sheet is required to have a textured surface, the final roller is provided with an appropriate embossing pattern. Alternatively, the film or sheet may be reheated and then passed through an embossing calender. The calender is followed by one or more cooling drums. Finally, the finished film or sheet is taken up by reel or the sheet may be cut into lengths and stacked.

The films or sheets of the present invention may have a smooth surface. Preferably, films or sheets to be used as an interlayer within laminates have a roughened surface to effectively allow most of the air to be removed from between the surfaces of the laminate during the lamination process. This may be accomplished, for example, by mechanically embossing the films or sheets after extrusion, as described above, or by melt fracture during extrusion of the films or sheets.

The films and sheets of the present invention may be further modified to provide valuable attributes. For example, the films and sheets of the present invention may be treated by radiation, for example E-beam treatment of the films and sheets. E-beam treatment of the films and sheets of the present invention with doses in the range of about 2 to about 20 MRd will provide increased softening point of the film and sheet (Vicat Softening Point) to a temperature of about 20° C. to about 50° C. Preferably, the radiation dose is from about 2.5 to about 15 MRd.

### Multilayer Films and Sheets

In a yet another aspect, the present invention provides multilayer films or sheets comprising at least one layer of the film or sheet of the present invention. One advantage of multilayer films and sheets is that the desirable properties of more than one polymeric material can be tailored into the structure, while the more costly ingredients can be relegated to the inner or outer layers, where they may more efficiently meet the requirements of the enduse. The multilayer film and sheet structures may be formed through coextrusion, blown film, dipcoating, solution coating, blade, puddle, air-knife, printing, Dahlgren, gravure, powder coating, spraying, plying of preformed films and sheets, or other processes known in the art. Generally, the multilayer films and sheets are produced through plying of preformed films and sheets or through extrusion casting processes.

The additional layers of the multilayer films and sheets of the present invention may comprise materials such as, without limitation, polyethylene, high density polyethylene, low density polyethylene, linear low density polyethylene, ultralow density polyethylene, polyolefins, poly(ethylene-co-glycidylmethacrylate), poly(ethylene-co-methyl (meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth)acrylic acid), metal salts of poly(ethylene-co-(meth)acrylic acid), poly((meth)acrylates), such as poly(methyl methacrylate), poly(ethyl methacrylate), and the like, poly(ethylene-co-carbon monoxide), poly(vinyl acetate), poly(ethylene-co-vinyl acetate), poly(vinyl alcohol), poly(ethylene-co-vinyl alcohol), polypropylene, polybutylene, polyesters, poly(ethylene terephthalate), poly(1,3-propylene terephthalate), poly(1,4-butylene terephthalate), PETG, poly(ethylene-co-1,4-cyclohexanedimethanol terephthalate), poly(vinyl chloride), PVDC, poly(vinylidene chloride), polystyrene, syndiotactic polystyrene, poly(4-hydroxystyrene), novalacs, poly(cresols), polyamides, nylon, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, sulfonated aliphatic-aromatic copolyesters, aliphatic-aromatic copolyesters, aliphatic polyesters, such as poly(1,4-butylene succinate), poly(ethylene succinate), poly(1,4-butylene adipate-co-succinate), poly(1,4-butylene adipate), polycarbonates, such as poly(ethylene carbonate) sold by the PAC Polymers Company, poly(hydroxyalkanoates), such as poly(hydroxybutyrate)s, poly(hydroxyvalerate)s, poly(hydroxybutyrate-co-hydroxyvalerate)s, poly(lactide-co-glycolide-co-caprolactone), poly(caprolactone), and poly(lactide), and the like and copolymers thereof and mixtures thereof.

### Laminates

In yet another aspect, the present invention provides a laminate comprising at least one layer derived from the film or sheet of the present invention. For example, the laminate of the present invention may be formed by laminating at least one layer of the film or sheet of the present invention with one or more layers of glass, polymeric films, polymeric sheets, metal films, metal sheets, and the like and combinations thereof. Preferably, the laminate of the present invention is a transparent laminate having at least one layer of glass and the film or sheet of the present invention.

As used herein, the term “/” designates adjacent layers. In some preferred embodiments of the invention, the adjacent layers are directly laminated to each other so that they are adjoining or, more preferably, contiguous.

Preferably, the structural integrity of the laminate is maintained after the breakage of the glass layer. More preferably, the structural integrity of the laminate is maintained after the breakage of the glass layer and after some additional stress, which may be repeated or prolonged, is applied to the laminate. The laminates of the present invention may incorporate additional films and/or sheets. Preferable additional films and/or sheets include biaxially oriented poly(ethylene terephthalate) films and solar control films. Preferably, the additional sheet layer, without limitation, is a sheet selected from the group consisting of sheets composed of a poly(vinyl butyral) composition, an acoustic polyvinyl acetal composition, an acoustic polyvinyl butyral composition, an ethylene vinyl acetate composition, an ethylene acid copolymer composition which incorporates acid functionality and ionomers derived therefrom, a thermoplastic polyurethane composition, polyvinyl chloride copolymer compositions, acoustic compositions, such as the ISD polyacrylate materials and the like and combinations thereof.

More preferably, the present invention provides a transparent laminate of two layers of glass laminated together with a film or sheet of the present invention. Preferably, the film or sheet of the invention is self-adhered to the glass. As used herein, when the thermoplastic polymer is said to be “self-adhered” to the glass, it is meant that there is no intermediate layer such as a primer or thin adhesive layer between the glass and the thermoplastic layer, nor has the surface of the glass or thermoplastic layer been specially treated. Preferably, the interlayer of the present invention has a Storage Young's Modulus of 50 to 1,000 MPa (mega Pascals) at 0.3 Hz and 25° C. as determined according to ASTM D 5026-95a, a Minimum Tear Energy of at least 15 MJ/m³ (mega joules per cubic meter) as determined from tensile tests carried out according to ASTM 638-89 at 25° C. and adhesion to glass of 5 to 42 MPa as determined according to Compressive Shear Strength Test determined at 25° C.

Compressive Shear Strength was determined using the method described in U.S. Pat. No. 6,599,630. Briefly, the compressive shear strength of the chip is the shear stress that is required to cause adhesive failure. The precision of this test is typically such that one standard deviation is 6% of the average of the measurements of the compressive shear strength of six chips.

The term “glass” includes window glass, plate glass, silicate glass, sheet glass, and float glass, but also includes colored glass, specialty glass which includes ingredients to control, for example, solar heating, coated glass with, for example, sputtered metals, such as silver or indium tin oxide, for solar control purposes, E-glass, Toroglass, Solex™ glass and the like. Such specialty glasses are described in, for example, U.S. Pat. Nos. 4,615,989; 5,173,212; 5,264,286; 6,150,028; 6,340,646; 6,461,736; and 6,468,934. The type of glass to be selected for a particular laminate depends on the intended use.

If even greater adhesion is required for a specific enduse, adhesives may be used. Adhesives will also find value within the present invention when other polymeric films and sheets are utilized within the laminate or when the polymeric layer adjacent to the glass is not an interlayer formed from the films and sheets of the present invention.

Essentially any adhesive known in the art of glass lamination will find utility within the present invention.

Adhesives may be applied through melt processes or through solution, emulsion, dispersion, and the like, coating processes. The process conditions and parameters for making coatings by any method in the art can be determined by a skilled artisan.

The laminate can be formed by through any suitable process known or yet to be known within the art. In a typical process, a glass sheet, an interlayer composed of a film or sheet of the amine-neutralized ethylene acid copolymer of the present invention, and a second glass sheet are laminated together under heat and pressure and a vacuum (for example, in the range of 27-28 inches (689-711 mm) Hg), to remove air. Preferably, the glass sheets have been washed and dried prior to lamination. A typical type of glass is 90 mil thick annealed flat glass and it is preferred to orient the tin side of the glass to the interlayer to achieve the optimal adhesion. In a typical procedure, the interlayer of the present invention is positioned between two washed glass plates to form a glass/interlayer/glass pre-press assembly, placing the pre-press assembly into a bag capable of sustaining a vacuum (“a vacuum bag”), drawing the air out of the bag using a vacuum line or other means of pulling a vacuum on the bag, sealing the bag while maintaining the vacuum, placing the sealed bag in an autoclave at a temperature of about 130° C. to about 180° C., at a pressure of about 200 psi (15 bars) for from about 10 to about 50 minutes. Preferably the bag is autoclaved at a temperature of from about 120° C. to about 160° C. for about 20 to about 45 minutes. More preferably the bag is autoclaved at a temperature of from about 135° C. to about 160° C. for about 20 to about 40 minutes. Most preferably the bag is autoclaved at a temperature of from about 145° C. to about 155° C. for about 25 to about 35 minutes. A vacuum ring may be substituted for the vacuum bag. One type of polymer bag is disclosed within U.S. Pat. No. 3,311,517.

Alternatively, other processes can be used to produce the laminates of the present invention. For example, the glass/interlayer/glass assembly may be heated in an oven at between 80° C. and 120° C., preferably between 90° C. and 100° C., for 30 minutes. Thereafter, the heated glass/interlayer/glass assembly can be passed through a set of nip rolls so that the air in the void spaces between the glass and the interlayer may be squeezed out, and the edge of the assembly sealed. The assembly may then be placed in an air autoclave where the temperature is raised to between about 120° C. and 160° C., preferably between about 135° C. and about 160° C., and pressure to between about 100 to about 300 psig, preferably about 200 psig (14.3 bar). These conditions are maintained for about 15 minutes to about 1 hour, preferably about 20 to about 50 minutes, after which, the air is cooled while no more air is added to the autoclave.

An abrasion resistant, hard coat may be applied to the laminate, especially to outer interlayers of the present invention or outer polymeric films and sheets. The hard coat helps to protect the outer polymeric layers from scratching, abrasion, and the like. Any conventional or non-conventional hard coat may be used. Some suitable hard coat compositions are described, for example, in U.S. Pat. No. 4,027,073.

For architectural uses and for uses in transportation such as automobiles, trucks, and trains, a typical laminate of the present invention has two layers of glass and directly self-adhered to the glass is an interlayer of the present invention. The laminate has an overall thickness of about 3 to about 30 mm. The interlayer typically has a thickness of about 0.38 to about 4.6 mm and each glass layer usually is at least 1 mm thick or thicker. The interlayer of the present invention is adhered directly to the glass and an intermediate adhesive layer or coating between the glass and the interlayer is not required. Similarly, multilayer structured laminates may be formed, such as a five layer laminate construct of glass/interlayer/glass/interlayer/glass, a seven layer laminate construct of glass/interlayer/glass/interlayer/glass/interlayer/glass, and the like.

The laminates of the present invention can also take the form of the interlayer of the present invention sandwiched between a layer of glass on one side and a polymeric film or sheet on the other. As described above, metal or ceramic plates may be substituted for the polymeric film or glass if clarity is not required for the laminate. The polymeric film or sheet may be composed of the polymers described above as “additional layers”. Preferably, the polymeric film or sheet is selected from the group consisting of polycarbonate, polyurethane, acrylic sheets, polymethylmethacrylate, polyvinyl chloride, polyester, and biaxially oriented poly(ethylene terephthalate). The polymeric films and sheets may additionally have functional coatings applied to them, such as sputtered metal or silver coatings and the like. Metal coated polymeric films and sheets are disclosed in, for example, U.S. Pat. Nos. 3,718,535; 3,816,201; 4,465,736; 4,450,201; 4,799,745; 4,846,949; 4,954,383; 4,973,511; 5,071,206; 5,306,547; 6,049,419; 6,104,530; 6,204,480; 6,255,031; and 6,565,982. As noted above, adhesives or primers may be included, especially to provide adequate adhesion between the other polymeric layer and the interlayer of the present invention or with the glass in multilayer laminates. Similarly, multilayer structured laminates can be formed.

Further contemplated are five layered laminates which are comprised of a glass layer, the interlayer of the present invention, a polymeric film or sheet layer, the interlayer of the present invention, and a glass layer. Beyond the polymeric films and sheets, both functional and not, as described above, the polymeric film and sheets may provide additional attributes, such as acoustical barriers. Polymeric films and sheets which provide acoustical dampening include, for example, ethylene vinyl acetate copolymers, ethylene methyl acrylate copolymers, plasticized polyvinyl chloride resins, metallocene-catalyzed polyethylene compositions, polyurethanes, highly plasticized polyvinyl butyral compositions, silicone/acrylate (“ISD”) resins, and the like. Such “acoustic barrier” resins are described in, for example, U.S. Pat. Nos. 5,368,917; 5,624,763; 5,773,102; and 6,432,522.

An alternate five layer laminate of the present invention would include a glass layer, a polymeric film or sheet layer, an interlayer of the present invention, a polymeric film or sheet, and a glass layer. One or both of the polymeric film or sheet layers may be a polyvinyl butyral layer, for example.

It is further contemplated that the laminates of the present invention may not include a glass layer. For example, a two layer laminate may include a polymeric film or sheet layer and an interlayer of the present invention. A three layer laminate may include either a polymeric film or sheet/interlayer of the present invention/polymeric film or sheet structure or an interlayer of the present invention/polymeric film or sheet/interlayer of the present invention structure. As described above, multilayer laminate structures are also contemplated.

This list of preferred embodiments is not limiting. The interlayers of the present invention may be used in essentially any laminate structure.

A further aspect of the present invention is the use of the laminates of the present invention preferably for architectural uses. The laminates are particularly useful in buildings subjected to hurricanes and wind storms, for windows that may be subjected to repeated insults, such as attempts to break into the building, or for structural elements such as staircases and balustrades, for example. The laminates of the present invention will find value in all modes of transportation, such as automobiles, trucks, trains, airplanes, ships, and the like, and particularly in windows for that may be subjected to repeated insults, such as attempts to break into the vehicle. The laminates of the present invention may be used in conjunction with the support structures that are described in PCT Patent Application Nos. WO 00/64670 and WO 2004/011755.

### EXAMPLES

The following Examples and Comparative Examples are presented to further illustrate the present invention. The Examples are not intended to limit the scope of the invention in any manner, nor should they be used to define the claims or specification in any manner that is inconsistent with the invention as claimed and/or as described herein.

### Methods

The following methods are used in the Examples and Comparative Examples presented hereafter.

### I. Amine Neutralization:

An appropriate amount of an ethylene acid copolymer was added to a 250 ml glass flask. The solid was then heated to 230° C. under a slow nitrogen purge. After reaching 230° C., the solid polymer became molten and an appropriate amount of amines in solid form or in solution were rapidly added to the stirred polymer melt under a nitrogen purge. As the melt viscosity rose, the reaction was discontinued after 0.1 to 0.4 hours and the resulting reaction product was allowed to cool to room temperature. An amine-neutralized ethylene acid copolymer resin was then recovered. The expected extent of neutralization is approximately equal to the number of equivalents of amine added to the copolymer in each preparation.

### II. Preparation of Amine-Neutralized Ethylene Acid Copolymer Sheets and Films:

To form a sheet or film made of an amine-neutralized ethylene acid copolymer, a sandwich consisting of Mylar® poly(ethylene terephthalate) films (biaxially stretched, not flame treated) on the top and bottom of a 5 inch by 5 inch (127 mm×127 mm) template which had a 0.05 inch (20 mils) thick opening and contained about 20 to about 25 grams of the amine-neutralized ethylene acid copolymer was placed onto the preheated platens of a Carver melt press at a temperature of 130° C. Pressure (300 psi) was applied to the assembly and held for 2 minutes. Additional pressure was then applied to the assembly (3000 psi) and held at 130° C. for 3 minutes. After the pressure was relieved, the assembly was removed from the Carver melt press, and the resulting laminate was rapidly quenched to room temperature. A 5 inch by 5 inch (127 mm×127 mm) and 20 mil thick sheet made of the amine-neutralized ethylene acid copolymer was therefore formed by stripping the Mylar® films off.

### III. Preparation of Laminates Comprising an Amine-Neutralized Ethylene Acid Copolymer Interlayer:

Laminates composed of a glass layer and a 20 mil thick layer of an amine-neutralized ethylene acid copolymer sheet were formed in the following manner. A 5 inch by 5 inch (127 mm×127 mm) and 20 mil thick amine-neutralized ethylene acid copolymer sheet was placed onto a 6 inch by 6 inch (153 mm×153 mm) and 2.5 mm thick annealed float glass plate. The glass/interlayer assembly was then placed into a vacuum bag and heated to 90° C. to 100° C. for 30 minutes to remove any air contained between the glass/interlayer assembly. The glass/interlayer pre-press assembly was then subjected to autoclaving at 135° C. for 30 minutes in an air autoclave to a pressure of 200 psig (14.3 bar). The air was then cooled while no more air was added to the autoclave. After 20 minutes of cooling and the air temperature was less than about 50° C., the excess pressure was vented, and the glass/interlayer laminate was removed from the autoclave.

Similarly, glass laminates composed of two glass layers and a polymeric interlayer made of amine-neutralized ethylene acid copolymer sheets were formed as follows. A 5 inch by 5 inch (127 mm×127 mm) and 20 mil thick amine-neutralized ethylene acid copolymer sheet was cut into 2 inch by 2 inch (51 mm×51 mm) squares. Three thicknesses of the sheets were placed ontop of each other to form an interlayer of 2 inch by 2 inch (51 mm×51 mm) square with an approximate thickness of 60 mils.

This interlayer was then sandwiched between two 2 inch by 2 inch (51 mm×51 mm) by 2.5 mm thick pieces of annealed float glass plates to produce a glass/interlayer/glass assembly and subject to heat and pressure.

### Example 1

In this example, 95.00 grams of poly(ethylene-co-methacrylic acid) which contains 22 wt % of copolymerized methacrylic acid and having an MI of 60 g/10 min were neutralized with 5.0333 grams of 5-amino-1,3,3-trimethylcyclohexane methylamine under a nitrogen purge at 230° C. for 0.1 hours, and 96.7 grams of the resulting amine-neutralized ethylene acid copolymer resin were recovered.

A sample of the amine-neutralized ethylene acid copolymer resin produced above then underwent differential scanning calorimetry (DSC) analysis. A broad recrystallization temperature was found on the programmed cool after the first heat cycle with an onset at 71.9° C. and a peak at 57.5° C. (9.6 J/g). A broad crystalline melting temperature (Tm) was observed at 85.6° C. (27.1 J/g).

A 5 inch by 5 inch (127 mm×127 mm) and 20 mil thick sheet made of the above obtained amine-neutralized ethylene acid copolymer was then formed.

### Comparative Example CE 1

In this example, 95.00 grams of poly(ethylene-co-methacrylic acid) which contains 19 wt % of copolymerized methacrylic acid and has an MI of 60 g/10 min were neutralized with 5.65 grams of 5-amino-1,3,3-trimethylcyclohexane-methylamine and an aqueous solution of sodium acetate (3.9817 grams of sodium acetate dissolved in 15.6198 grams water) under a nitrogen purge at 230° C. for 0.3 hours, and 99.8 grams of the amine-neutralized ethylene acid copolymer resin were recovered.

By DSC analysis, a broad recrystallization temperature was found on the programmed cool after the first heat cycle with an onset at 71.8° C. and a peak at 57.4° C. (25.2 J/g), and a broad crystalline Tm was observed at 89.7° C. (35.0 J/g).

### Example 2

In this example, 95.00 grams of poly(ethylene-co-methacrylic acid) which contains 22 wt % of copolymerized methacrylic acid and has an MI of 60 g/10 min were neutralized with 5.0333 grams of 5-amino-1,3,3-trimethylcyclohexane methylamine and an aqueous solution of sodium acetate (3.9858 grams of sodium acetate dissolved in 15.0511 grams water) under a nitrogen purge at 230° C. for 0.3 hours, and 99.4 grams of the amine-neutralized ethylene acid copolymer resin were recovered.

By DSC analysis, a broad recrystallization temperature was found on the programmed cool after the first heat cycle with an onset at 72.2° C. and a peak at 58.6° C. (4.5 J/g), and a broad crystalline Tm was observed at 87.1° C. (23.7 J/g).

A 5 inch by 5 inch (127 mm×127 mm) and 20 mil thick sheet made of the above obtained amine-neutralized ethylene acid copolymer was formed.

Thereafter, laminates comprising a glass layer and a 20 mil thick layer of the above formed amine-neutralized ethylene acid copolymer sheet and laminates comprising two glass layers and a polymeric interlayer made of the above formed amine-neutralized ethylene acid copolymer sheets were formed under heat and pressure.

Comparing to the Comparative Example CE1, the amine-neutralized ethylene acid copolymer produced in Example 2 demonstrated reduced levels of crystallinity and therefore would provide enhanced clarity, a valuable attribute, to the compositions, shaped articles, and laminates of the present invention.

Moreover, the glass laminates incorporating an interlayer made of these amine-neutralized ethylene acid copolymers demonstrate a further aspect of the present invention. That is, the amine-neutralized ethylene acid copolymer interlayer adhered to the glass layer(s) without the use of adhesives.

### Example 3

In this example, 90.00 grams of poly(ethylene-co-methacrylic acid) which contain 22 wt % of copolymerized methacrylic acid and have a MI of 60 g/10 min were neutralized with 10.0142 grams of 5-amino-1,3,3-trimethylcyclohexane methylamine under a nitrogen purge at 230° C. for 0.2 hours, and 93.0 grams of the amine-neutralized ethylene acid copolymer resin were recovered.

By DSC analysis, a broad recrystallization temperature was found on the programmed cool after the first heat cycle with an onset at 70.3° C. and a peak at 58.6° C. (2.3 J/g) and a broad crystalline Tm was observed at 86.4 C (17.8 J/g).

A 5 inch by 5 inch (127 mm×127 mm) and 20 mil thick sheet of the above obtained amine-neutralized ethylene acid copolymer were formed.

### Example 4

In this example, 95.00 grams of poly(ethylene-co-methacrylic acid) which contain 22 wt % of copolymerized methacrylic acid and have a MI of 60 g/10 min were neutralized with an aqueous solution of hexamethylenediamine (7.1705 grams, 70 wt %) and an aqueous solution of zinc acetate dihydrate (3.2000 grams of sodium acetate dissolved in 12.0476 grams of water) under a nitrogen surge at 230° C. for 0.4 hours, and 94.6 grams of the amine-neutralized ethylene acid copolymer resin were recovered.

By DSC analysis, a broad recrystallization temperature was found on the programmed cool after the first heat cycle with an onset at 74.2° C. and a peak at 59.1° C. (33.7 J/g), and a broad crystalline Tm was observed at 85.1° C. (35.3 J/g).

A 5 inch by 5 inch (127 mm×127 mm) and 20 mil thick sheet made of the above obtained amine-neutralized ethylene acid copolymer was formed.

Glass laminates comprising two glass layers and one interlayer made of the above formed amine-neutralized ethylene acid copolymer sheet were also formed. Here again, the amine-neutralized ethylene acid copolymer interlayer adhered to the glass layer(s) without the use of adhesives.

### Example 5

In this example, 90.00 grams of poly(ethylene-co-methacrylic acid) which contain 22 wt % of copolymerized methacrylic acid and have a MI of 60 g/10 min were neutralized with a 70 wt % aqueous solution of hexamethylenediamine (14.3014 grams) under a nitrogen purge at 230° C. for 0.3 hours, and 90.2 grams of the amine-neutralized ethylene acid copolymer resin were recovered.

By DSC analysis, a broad recrystallization temperature was found on the programmed cool after the first heat cycle with an onset at 50.9° C. and a peak at 42.4° C. (3.6 J/g), and a broad crystalline Tm was observed at 86.5° C. (12.8 J/g).

A 5 inch by 5 inch (127 mm×127 mm) and 20 mil thick sheet made of the above obtained amine-neutralized ethylene acid copolymer was formed.

### Comparative Example CE 2

In this example, 97.50 grams of poly(ethylene-co-methacrylic acid) which contain 19 wt % of copolymerized methacrylic acid and have a MI of 60 g/10 min were neutralized with 2.5166 grams of 1,3-cyclohexane bis(methylamine) under a nitrogen purge at 230° C. for 0.2 hours, and 96.6 grams of the amine-neutralized ethylene acid copolymer resin were recovered.

By DSC analysis, a broad recrystallization temperature was found on the programmed cool after the first heat cycle with an onset at 73.7° C. and a peak at 62.8° C. (35.9 J/g), and a broad crystalline Tm was observed at 87.9° C. (50.8 J/g).

### Example 6

In this example, 97.50 grams of poly(ethylene-co-methacrylic acid) which contain 22 wt % of copolymerized methacrylic acid and have a MI of 60 g/10 min were neutralized with 2.5135 grams of 1,3-cyclohexane bis(methylamine) under a nitrogen purge at 230° C. for 0.1 hours, and 101.9 grams of the amine-neutralized ethylene acid copolymer resin were recovered.

By DSC analysis, a broad recrystallization temperature was found on the programmed cool after the first heat cycle with an onset at 74.1° C. and a peak at 59.2° C. (27.6 J/g), and a broad crystalline Tm was observed at 84.8° C. (35.6 J/g).

Here again, comparing to Comparative Example CE 2, the amine-neutralized ethylene acid copolymers of Example 6 demonstrate reduced levels of crystallinity.

A 5 inch by 5 inch (127 mm×127 mm) and 20 mil thick sheet made of the above obtained amine-neutralized ethylene acid copolymer and laminates comprising a glass layer and a 20 mil thick layer of the 5 inch by 5 inch (127 mm×127 mm) sheet were also formed without the use of adhesives.

### Example 7

In this example, 95.00 grams of poly(ethylene-co-methacrylic acid) which contain 22 wt % of copolymerized methacrylic acid and have a MI of 60 g/10 min were neutralized with 4.9684 grams of 1,3-cyclohexane bis(methylamine) under a nitrogen purge at 230° C. for 0.2 hours, and 96.5 grams of the amine-neutralized ethylene acid copolymer resin were recovered.

By DSC analysis, a broad recrystallization temperature was found on the programmed cool after the first heat cycle with an onset at 71.2° C. and a peak at 55.3° C. (19.2 J/g), and a broad crystalline Tm was observed at 84.0° C. (30.0 J/g).

A 5 inch by 5 inch (127 mm×127 mm) and 20 mil thick sheet made of the above obtained amine-neutralized ethylene acid copolymer and glass laminates comprising two glass layers and one60 mil thick polymeric interlayer made of three thickness of such sheets were formed without the use of adhesives.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A resin composition comprising a neutralized ethylene acid copolymer, wherein said neutralized ethylene acid copolymer comprises copolymerized residues of ethylene and from about 21 to about 25 wt %, based on the total weight of the ethylene copolymer prior to neutralization, of copolymerized residues of at least one α,β-unsaturated carboxylic acid having from 3 to 8 carbons, wherein said acid residues are neutralized to a level of about 1 to about 100 mol %, based on the total number of moles of carboxylate groups in the ethylene acid copolymer, with one or more amines.

2. The resin composition of claim 1, wherein said neutralized ethylene acid copolymer has a melt index of about60 g/l 0 min or less prior to neutralization.

3. The resin composition of claim 2, wherein said neutralized ethylene acid copolymer has a melt index of about 50 g/10 min or less prior to neutralization.

4. The resin composition of claim 3, wherein said neutralized ethylene acid copolymer has a melt index of about 35 g/10 min or less prior to neutralization.

5. The resin composition of claim 1, wherein said ethylene acid copolymer comprises from about 21 to about 23 wt % of copolymerized residues of carboxylic acids, based on the total weight of the ethylene acid copolymer prior to neutralization.

6. The resin composition of claim 1, wherein said one or more amines are selected from the group consisting of aliphatic diamines, cycloaliphatic diamines, aliphatic triamines, cycloaliphatic triamines, aliphatic polyamines and cycloaliphatic polyamines.

7. The resin composition of claim 1, wherein said acid residues are neutralized to a level of about 10 to about 90 mol %, based on the total number of moles of carboxylate groups in the ethylene acid copolymer, with one or more amines.

8. The resin composition of claim 7, wherein said acid residues are neutralized to a level of about 20 to about 80 mol %, based on the total number of moles of carboxylate groups in the ethylene acid copolymer, with one or more amines.

9. The resin composition of claim 1, wherein said neutralized ethylene acid copolymer is further neutralized with at least one metallic ion.

10. The resin composition of claim 1, wherein said ethylene acid copolymer further comprises a finite amount up to about 50 wt %, based on the total weight of the neutralized copolymer, of at least one other unsaturated comonomer, wherein said at least one other unsaturated comonomer is a derivative of an unsaturated acid having from 2 to 10 carbons.

11. The resin composition of claim 1, further comprising at least one additive.

12. The resin composition of claim 11, wherein said at least one additive is selected from the group consisting of thermal stabilizers, UV absorbers, UV stabilizers, plasticizers, processing aides, flow enhancing additives, lubricants, pigments, dyes, flame retardants, impact modifiers, nucleating agents, and anti-blocking agents.

13. The resin composition of claim 12, wherein said thermal stabilizer is a secondary thermal stabilizer.

14. The resin composition of claim 12, wherein said UV stabilizer is an hindered amine light stabilizer (HALS).

15. A shaped article comprising the resin composition of claim 1.

16. The shaped article of claim 15, which is a film, a sheet, a filament, a molded product, or a thermoformed product.

17. The shaped article of claim 15, which has smooth surfaces.

18. The shaped article of claim 15, which has at least one rough surface.

19. A multilayer film or sheet comprising at least one layer comprising the resin composition of claim 1.

20. A laminate article comprising at least one layer comprising the resin composition of claim 1.

21. The laminate article of claim 20, further comprising at least one layer selected from the group consisting of glass, polymeric films, polymeric sheets, metal films, and metal sheets.

22. The laminate article of claim 20, further comprising at least one layer of glass, and wherein said at least one interlayer is self-adhered to said at least one layer of glass.

23. The laminate article of claim 20, further comprising two layers of glass with said at least one interlayer laminated between and self-adhered to said two layers of glass.
